(19) United States
(12) Patent Application Publication
(10) Pub. No.: US 2012/0099754 A1
(43) Pub. Date: Apr. 26, 2012

(54) AUDIO ACCESSORY

(76) Inventor: Erik Petersén, Nacka (SE)

(21) Appl. No.: 13/380,790

(22) PCT Filed: Jun. 25, 2009
(86) PCT No.: PCT/SE2009/050815

§ 371 Date: Dec. 23, 2011

(51) Int. Cl. H04R 1/10

(52) U.S. Cl. 381/379

(57) ABSTRACT

In an audio headphone assembly (1) having a pair of earpieces (3, 5) with associated speaker units (4, 6), being attached generally to an end region (2C, 2D) of head band (2), whereby each earpiece is associated with the headband, for adjustment of the position of the ear-pieces relative to the head band in at least two senses, are provided wire loops (7, 8) that each have two spaced legs that at one end are attached to a respective earpiece and that are inter-connected at a second end (7C, 8C), earpiece hinges (9, 14) that are each supported at a respective headband end area (2C, 2D) and that each have a hinge body with a first through-bore extending through the body for receiving a first leg of a loop for rotation and for longitudinal displacement and with a second through bore extending through the hinge body and being open to the outside of the hinge body at one side for receiving the second loop leg through a pivoting movement of the loop around an axis of the first leg.

### TECHNICAL FIELD

The present invention generally concerns audio accessories and specifically relates to audio headphones/headsets.

### BACKGROUND

Headphones and/or headsets are presently used by people of various ages and in a wide range of different applications, such as for listening to music, listening to audio books and for communicating over the telephone or through a computer. In most of such applications the sound quality is naturally of great importance. However, it is likewise essential that the headphones are comfortable and appropriately fit the user, especially if used during extended time periods. To this end the headphones may have a headband that is made from a resilient material so as to provide comfortable and uniform pressure of headphone earpieces or ear caps against the ears of any user. The headphones may also be adjustable in size to fit the ear position of each individual user.

Another feature that may also be of importance to the user of headphones is that the earpieces are adjustable from a listening position extended generally perpendicular to a general plane of the headband and to a position where the earpieces are extended generally in said plane. Such adjustment makes it more comfortable for a user to wear the headphones around the neck during a pause in the listening. Yet another desirable feature that is quite common is that the headphones are easily foldable so that they may be easily placed in a bag or even a pocket when not in use.

Numerous solutions have been suggested for headphone adjustment mechanisms that provide at least some of the discussed types of adjustment functions for headphones. However, most of such prior art solutions, and specifically those that provide more than one adjustment function, are complex with separate mechanisms for each function. This renders the headphones expensive to manufacture and in many cases renders the adjustment mechanisms awkward and even unaesthetic.

### SUMMARY

There is a general need for solutions enabling the production of comfortable and appropriately adjustable audio headphone assemblies at reasonable cost. It is therefore a general object of the present invention to provide an improved, easily adjustable headphone assembly having an uncomplicated and inexpensive adjustment configuration.

It is a particular object of the invention to suggest a headphone assembly having an improved adjustment configuration that allows easy and versatile adjustment for adaption both to different users and to different phases of use and that may also be manufactured in a cost efficient way.

According to another aspect of the invention it is an object thereof to provide a headphone assembly having an improved adjustment configuration that at a reasonable cost allows for easy and versatile adjustment in three distinct senses.

These and other objects are met by the invention as defined in the patent claims.

The invention generally relates to a type of headphone or headset assemblies that comprises a head band having an earpiece and speaker element attached to each end area thereof. Specifically, it relates to such assemblies where the position of the earpiece in relation to the head band is adjustable both for controlling the size of the headphone assembly and for setting the earpieces in active listening or inactive wearing positions. To achieve an easily maneuverable and inexpensive adjustment configuration, a basic idea of the invention is to provide such an adjustment configuration wherein the size control function as well as the earpiece positioning function is combined in one and the same adjustment mechanism. This combined adjustment mechanism comprises wire loops having two spaced legs that are attached to an earpiece at one end and that are interconnected at a second end, earpiece hinges being supported at an end area of the headband and having a body with a first through-bore that extends through the body for receiving a first loop leg for rotation around its own axis and a second through-bore that extends through the body and that along its length is open to the outside for receiving the second loop leg through pivoting movement of the loop around the axis of the first leg. This enables the use of few component parts and thus very cost effective manufacturing.

According to another aspect of the invention there is provided a further improved headphone assembly allowing for additional adjustment. A basic idea of this aspect is to provide cylindrical hinge bodies that are supported for rotation at an associated end section of the head band, thereby permitting folding of the respective earpieces towards the headband for storage or stowage. This will add a further combined adjustment function to the same adjustment mechanism, rendering it even more cost effective in terms of functionality versus cost.

Preferred further developments of the basic inventive idea as well as embodiments thereof are specified in the dependent subclaims.

Advantages offered by the present invention, in addition to those described, will be readily appreciated upon reading the below detailed description of embodiments of the invention.

### BRIEF DESCRIPTION OF THE DRAWINGS

The invention and further objects and advantages thereof will be best understood by referring to the following description taken together with the accompanying drawings, in which:

FIG. 1 is a schematical perspective view of an embodiment of a headphone assembly according to the invention;

FIG. 2 is a detail view of an earpiece with wire loop of the assembly of FIG. 1;

FIG. 3 is a schematical detail view of an earpiece hinge at an head band end area of the headphone assembly of FIG. 1;

FIG. 4 is a partial side view of an adjustment mechanism of the assembly of FIG. 1;

FIG. 5 is a longitudinal section along line A-A in FIG. 4, of the hinge body of the adjustment mechanism;

FIG. 6A is a perspective view of the adjustment mechanism in a listening position;

FIG. 6B is a top view, in partial cross-section, of the adjustment mechanism in the listening position;

FIG. 7A is a perspective view of the adjustment mechanism in a wearing position;

FIG. 7B is a top view, in partial cross-section, of the adjustment mechanism in the wearing position;

FIGS. 8A-B are schematical front views of the headphone assembly of FIG. 1 in the listening and wearing positions, respectively;

FIG. 9 is a front view similar to those of FIGS. 8A-B, of the headphone assembly of FIG. 1 in a storage position; and

FIG. 10 is a front view similar to that of FIG. 9, of a variation of the headphone assembly of the invention.

### DETAILED DESCRIPTION

The invention will now be explained with reference to exemplifying embodiments thereof, which are illustrated in the accompanying drawing figures. In said drawing figures are disclosed schematical embodiments of the inventive headphone configuration. The illustrated and later described exemplifying embodiments of the invention relate to an application of the inventive solution to a schematically outlined headphone assembly. It shall be emphasized, though that the illustrations are for the purpose of describing preferred embodiments of the invention and are not intended to limit the invention to the details thereof. Likewise, it shall be emphasized that the term “headphone” shall for the purposes of this invention also include similar accessories, such as headsets etc.

It has been recognized by the inventor, and was discussed briefly in the introduction, that conventional headphones having plural adjustment functions are generally provided with rather complex adjustment mechanism configurations. This is partly due to the fact that physically separated hinges and other mechanisms are used to perform various adjustment functions. The result of such configurations is not only rather complicated and costly fabrication processes that in most cases involve the handling and assembly of many separate component parts. In addition, such prior art headphone or headset assemblies for the most part suffer from becoming rather bulky and unaesthetic with regard to the adjustment mechanisms.

To overcome the described disadvantages and problems associated with both the appearance and the production of known headphone assemblies having plural adjustment functions, the invention suggests a new approach to such an adjustment mechanism configuration. In accordance with the solution presented by the invention advantageous improvements are achieved in terms of uncomplicated function, slim and appealing appearance and a reduced fabrication and assembly cost. Basically, all of the advantageous effects of the invention are achieved by the unique combination of several adjustment functions in one and the same adjustment mechanism.

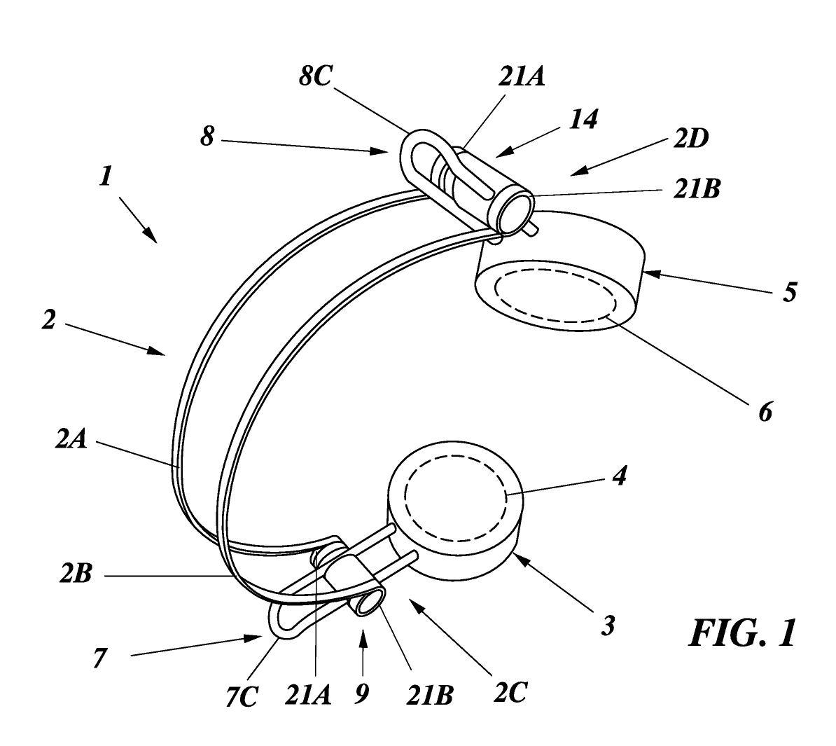

The invention will be explained in detail below and with reference to the exemplifying embodiments thereof that are illustrated in the accompanying drawing figures. One embodiment of the invention is illustrated in FIGS. 1-9 and relates to an application of the inventive solution to a schematically outlined headphone assembly 1 of the general type having a pair of earpieces or ear caps 3, 5 with associated speaker units 4, 6 (only very schematically indicated). The earpieces 3, 5 are attached generally to a respective end region 2C, 2D of an interconnecting head band 2 and are directly or indirectly adjustably associated with the head band, for adjustment of the position of the earpieces relative to the head band in at least two senses.

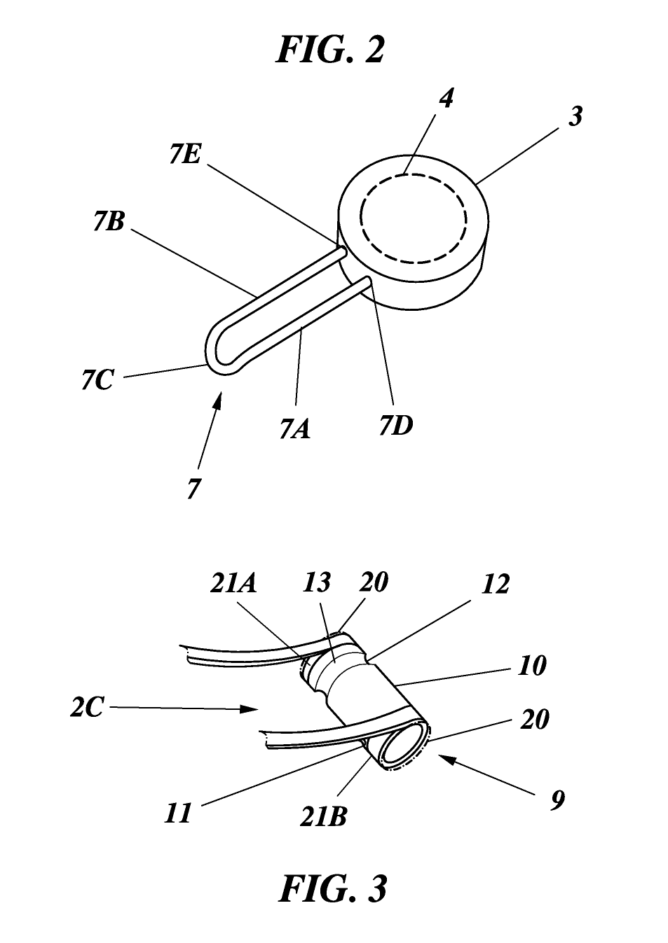

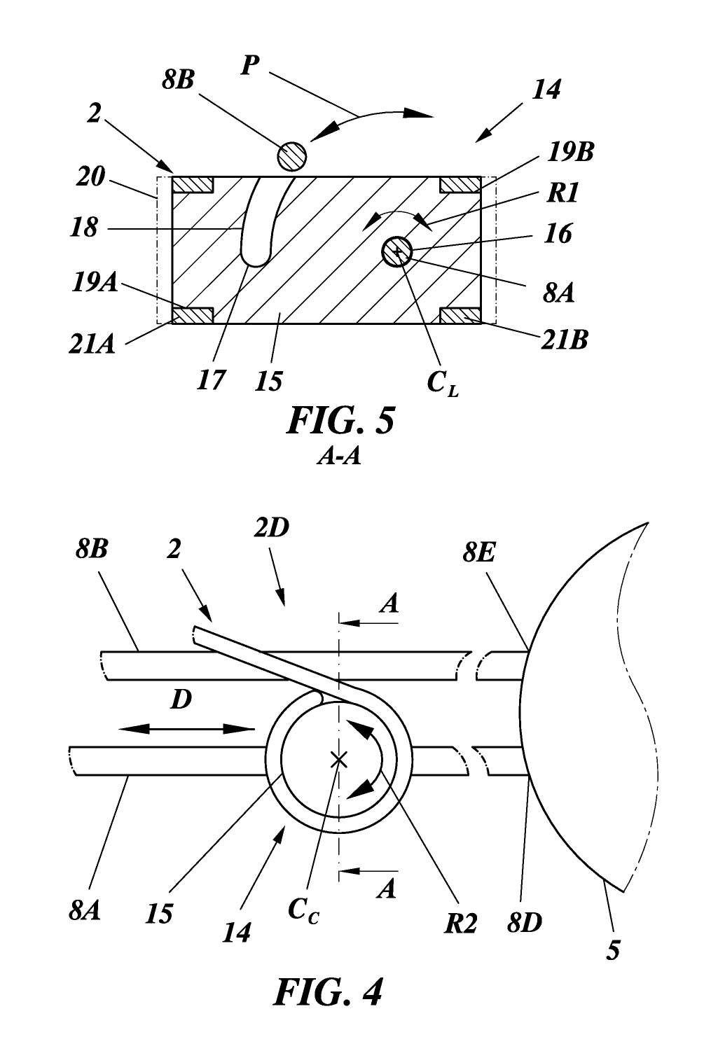

According to the invention an adjustment mechanism combining plural adjustment functions comprises wire loops 7 and 8 for adjustably supporting the respective earpieces 3, 5. The wire loops 7, 8 each have two essentially parallel spaced legs 7A, 7B and 8A, 8B, respectively, that at one end 7D, 7E and 8D, 8E, respectively, are attached to an earpiece 3, 5, at a distance from each other that essentially corresponds to the spacing between said legs. The legs of the wire loops 7, 8 are interconnected at a second end 7C and 8C, respectively (see especially FIGS. 2 and 4). The wire loops 7, 8 may consist of metal wire material, but other materials having appropriate characteristics, such as synthetic resin materials, may likewise be employed.

For each earpiece 3, 5 the adjustment mechanism further comprises a hinge that is generally denoted 9 and 14, respectively and that is supported at a dedicated headband end area 2C and 2D, respectively. The hinges 9, 14 each consist of a hinge body 10, 15 that in this embodiment is shown as a generally circular cylinder that is supported for rotation (arrow R2 in FIG. 4) at an associated end section 2C, 2D of the head band 2. This will provide an additional adjustment function allowing for a folding of the earpieces 3, 5 inwardly towards each other and towards the head band 2 for storage, as will be described below in association with FIG. 9.

In the illustrated embodiment the head band 2 consists of two generally parallel, spaced band members 2A, 2B that at their respective ends (at the corresponding head band end regions 2C, 2D) are provided with hinge seats 21A, 21B that may be separately attached thereto or may be formed integral with the band members 2A, 2B. The cylinder hinge bodies 10, 15 are supported for the rotation R2 around the cylinder centre axis C_{C} in the seats 21A, 21B. In particular, a portion 19A, 19B having a reduced diameter is formed at each end of the cylinder hinge body 10, 15 and is journalled in a corresponding seat 21A, 21B at the end of the respective band members 2A, 2B. In such an embodiment the cylinder hinge bodies 10, 15 may not only be supported in the seats 21A, 21B but may also literally interconnect the two head band members 2A, 2B. In the latter case and in the described embodiment where the hinge bodies 10, 15 are supported for rotation in the seats 21A, 21B, a stop 20 (vaguely indicated in FIGS. 3 and 5) or other means should be provided at each hinge body end to prevent inadvertent disassembly.

Each of the hinge bodies 10, 15 is provided with a first circumferentially mainly continuous through-bore 11, 16. The first through-bore 11, 16 extends generally diametrically through the respective body 10, 15 for receiving a first leg 7A, 8A of a respective wire loop 7, 8 for rotation (arrow R1 in FIG. 5) around a center axis C_{L} of the loop 7, 8 and for longitudinal displacement (arrow D in FIG. 4) in the direction of said axis C_{L} that may also denote the centre axis of the first through-bore 11, 16. Each of the hinges 9, 14 further has a second through-bore 12, 17 that likewise extends generally diametrically through the respective hinge body 10, 15. The first 11, 16 and second 12, 17 through-bores are extended through the respective hinge body 10, 15 generally perpendicular to a centre axis C_{c} of the body and at a distance from each other along said centre axis that essentially corresponds to the distance between the parallel loop legs 7A, 7B, 8A, 8B. Along its full length the second through-bore 12, 17 is open to the outside of the associated hinge body 10, 15 at one side, at 13, 18. The purpose of this open bore is to allow the second loop leg 7B, 8B to be releasably received in the second bore 12, 17 through a pivoting movement (arrow P in FIG. 5) of the loop 7, 8 around the axis C_{L} of the first loop leg 7A, 8A. In the position where it is pivoted into the second through-bore 12, 17 of the hinge body 10, 15, the second loop leg 7B, 8B of each loop 7, 8 is preferably likewise received in the respective hinge body for longitudinal displacement in the direction of said leg.

To permit easy, stepless adjustment of the size of the headphones through adjustment of the position of the earpieces 3, 5 relative to the head band 2 and to allow the earpieces to maintain a set position the first the loop leg 7A, 8A will preferably be received with a certain interference fit in the associated first through-bore 11, 16. Likewise, to further improve this function, the second loop leg 7B, 8B may likewise be received with a certain interference fit in the associated second through-bore 12, 17.

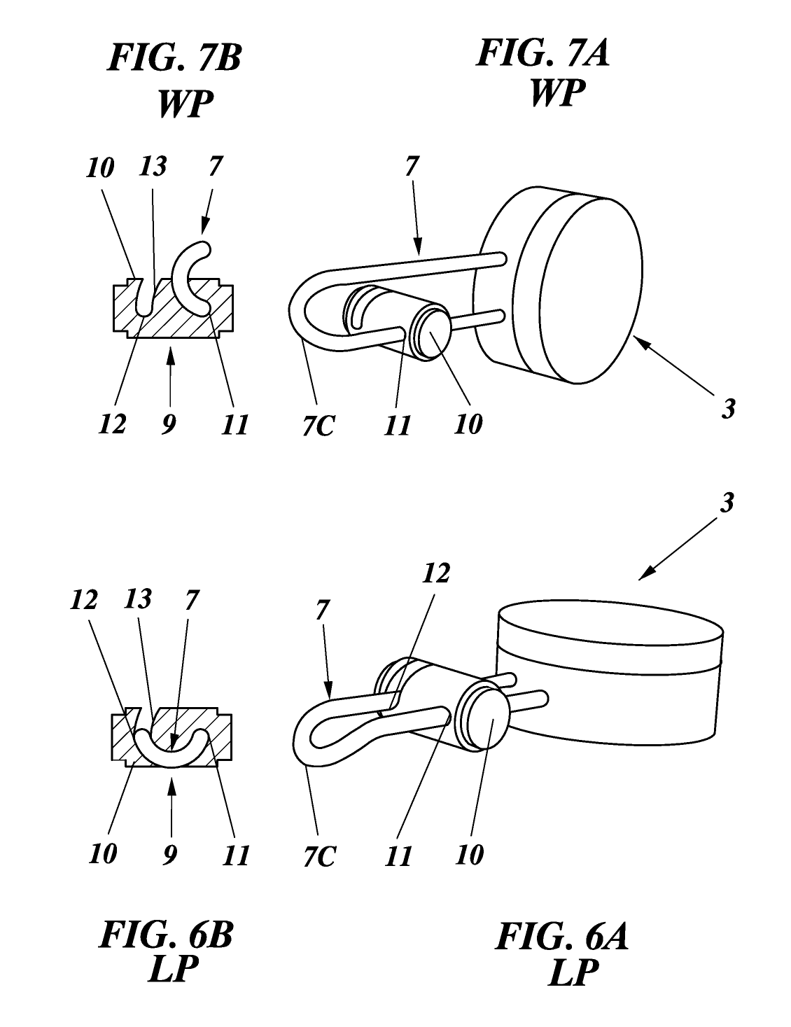

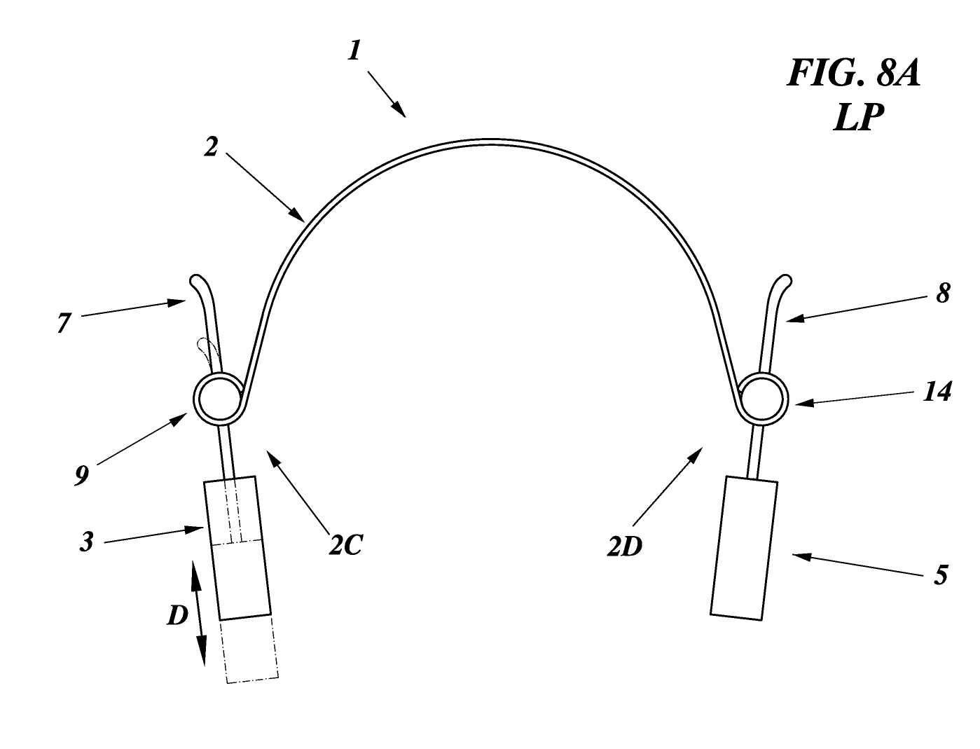

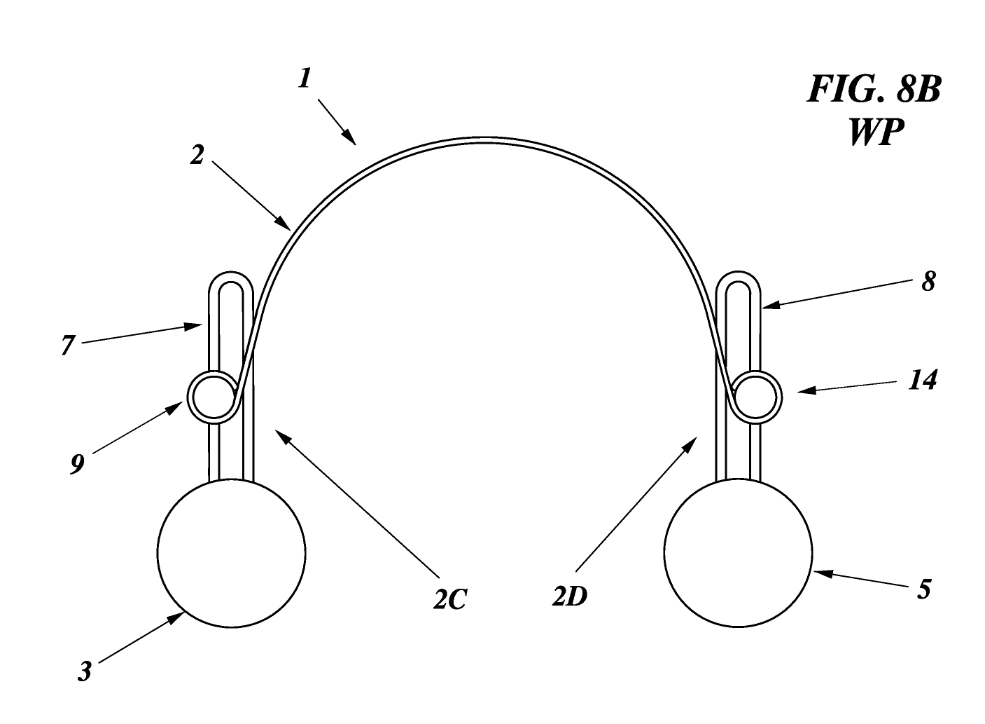

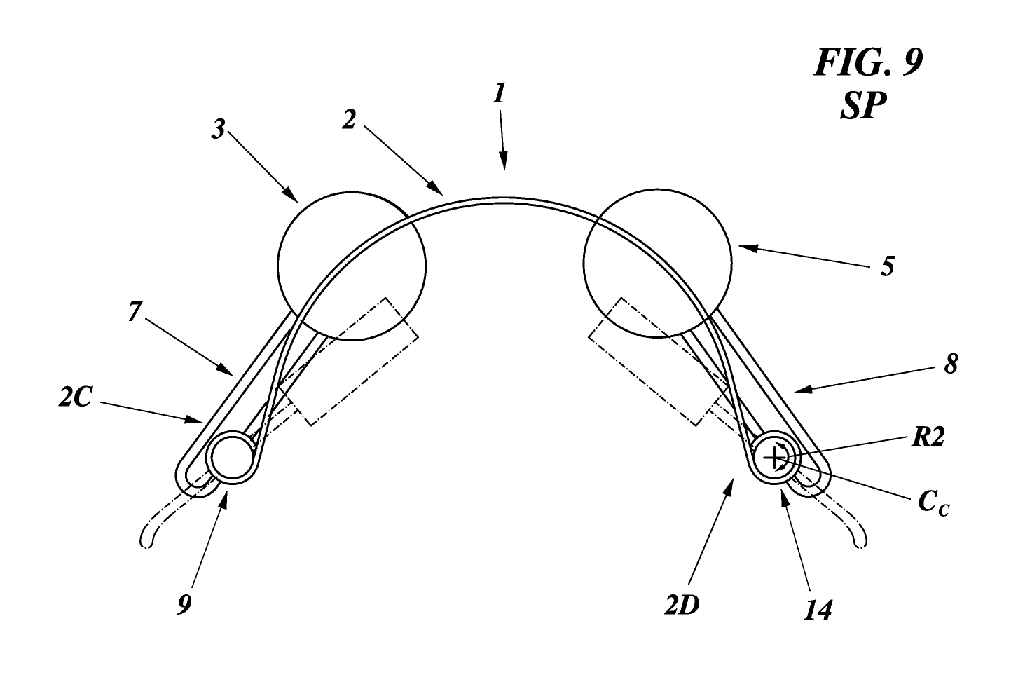

As will be seen especially in FIGS. 5, 6B and 7B, the open side of the second through-bore 12, 17 is preferably formed by a groove 13, 18 extending the full length of the second through-bore, from the second bore 12, 17 circumference to the outside of the hinge body 10, 14. As seen in a longitudinal section through the respective hinge body 10, 14, the groove 13, 18 has an arcuate shape that coincides with a portion of a circle being centered on a centre axis C_{L} of the first through-bore 11, 15. In a further development of the adjustment mechanism at least parts of the arcuate groove 13, 18 is slightly narrower than the cross-sectional dimension of the second loop leg 7B, 8B, to thereby present a moderate resistance to an insertion of the second loop leg 7B, 8B through the groove 13, 18 and into the second through-bore 12, 17 and to a removal of the second loop leg from said second through-bore. This will maintain the earpieces 3, 5 securely in a listening position LP, as depicted in FIGS. 6A, 6B and 8A, during normal use.

The above mentioned objects of the invention are achieved by means of the described headphone assembly 1 that provides the essential improvements with regard to convenient adjustment and cost efficient production.

With the described combined adjustment mechanism the headphone assembly of the invention may be easily adjusted for size by simply sliding the earpiece/earpieces 3, 5 in the optional direction D on the associated wire loop/loops 7, 8, as is schematically indicated in FIG. 8A. A further adjustment function is permitted by the formation of the second through-bore 12, 17 with its sideways opening groove 13, 18 that allows the wire loops 7, 8 to be swung from an active listening position LP that is depicted in FIGS. 6A-B and 8A and to a comfortable inactive wearing position WP that is depicted in FIGS. 7A-B and 8B. In the listening position LP the wire loops 7, 8 are swung so that the second loop leg 7B, 8B is positioned completely inside the associated through-bore 12, 17, which in turn means that the earpieces are positioned generally aligned with the associated cylinder hinge body 10, 15 or, expressed otherwise, perpendicular to a general plane of the head band 2. In this position the earpieces rest comfortably against the ears of a user. For the adjustment to the inactive wearing position WP, the wire loops 7, 8 are rotated around the centre axis C_{L} of the first loop leg 7A, 8A so that the second loop leg 7B, 8B is swung out from the second through-bore 12, 17 and the associated arcuate groove 13, 18. This in turn positions the earpieces generally perpendicular to the associated cylinder hinge body 10, 15 or, expressed otherwise, aligned with a general plane of the head band 2. In this inactive wearing position WP the earpieces rest comfortably on the upper chest or lower neck of the user, without risking any uncomfortable squeezing of the earpieces between the chin and the upper chest of said user.

Another essential benefit of the described embodiment is the possibility of optionally adding a further, third adjustment function. This is achieved by the rotary support of the cylinder hinge bodies 10, 15 in the head band 2 end sections 2C, 2D and enables the rotation (arrow R2) of the complete earpiece 3, 5 and hinge 9, 14 combinations around the centre line C_{C} of the cylinder hinge bodies 10, 15 to a storage or stowage position SP that is shown in FIG. 9. As is indicated in FIG. 9 the earpieces 3, 5 may be swung to the storage position SP, either in their listening position LP or in their inactive wearing position WP. It should be noted that with the inventive adjustment configuration all of the three discussed adjustment functions may be realized in one and the same mechanism comprising the wire loop and the hinge body.

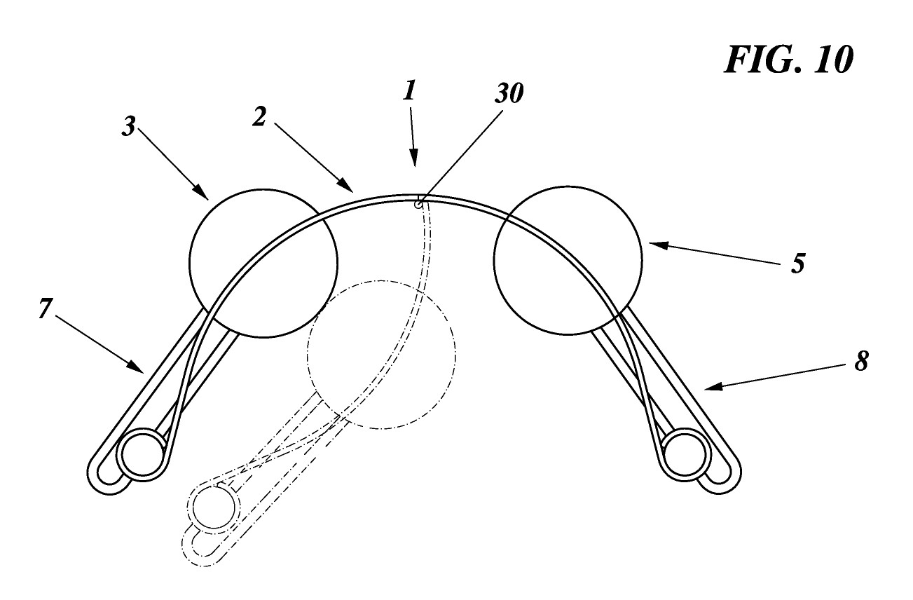

Another embodiment that is a slightly modified variation of the first embodiment of the headphone assembly of the invention is illustrated in FIG. 10. This variation is based on the same general principles as the described first embodiment and therefore only the major differences will be described in detail below and corresponding or similar parts have been given the same reference numerals. This variation shows that the inventive solution may with great benefit be combined with the provision of a head band hinge 30 approximately half-way along the head band, as is in itself well known within the prior art. With the addition of such a head band hinge 30, the entire headphone assembly may be folded to an extremely compact stowage position SP2.

Although the invention has been described and illustrated with specific reference to an exemplifying embodiment of a type of headphone assembly to which the basic principles of the invention may be applied, it shall be emphasized that the invention likewise covers numerous variations of the specific configuration of component parts thereof. As an example of such alternative, but not specifically illustrated embodiments of the invention, the earpiece hinge bodies may not be formed as circular cylinders but with other geometric shapes. Examples thereof are bodies with an elliptical, square or other polygonal cross-section, and accordingly not being supported for rotation at the head band end sections. In such a configuration the adjustment mechanism may therefore only have two adjustment functions. Likewise, in the widest scope of the invention it is not necessary that the loop legs and the associated through-bores should have the illustrated circular cross-section. Other cross-sections may optionally be used for either or both of the loop legs and the through-bores. Polygonal, elliptical cross-sectional shapes are possible in different combinations as long as the loop leg shape and the through-bore shape are so adapted to each other that the described displacement and rotation/swinging of the loop legs is still allowed, preferably overcoming a frictional resistance. Available cross-section combinations may be exemplified by an octagonal loop leg section fitting tightly in a circular bore—with its diagonal substantially equal to the diameter of the bore—or reverse; an elliptical loop leg section fitting tightly in a circular bore, or reverse; or square sections, with slightly different, mutually fitting dimensions, for both the second loop leg and the second through-bore. Several other cross-sectional combinations are possible. Finally, the head band must not consist of two separated, generally parallel parts. It could be formed of one broader or narrower band having a hinge body support provided at its end sections.

The invention has been described in connection with what is presently considered the most practical and preferred embodiments, but it is to be understood that the invention is not limited to the disclosed embodiments. The invention is therefore intended to cover various modifications and equivalent arrangements included within the spirit and scope of the appended claims.

1. An audio headphone assembly comprising:
a head band;
a pair of earpieces with associated speaker units, being attached to a respective end region of the head band, such that the position of the earpieces is adjustable relative to the head band in at least two senses;
wire loops, each having a first leg and a second leg that at one end are attached to a respective earpiece and that are inter-connected at a second end; and
earpiece hinges, each being supported at a respective end region of the head band, and each earpiece hinge having
a hinge body;
a first through-bore that extends through the hinge body and receives the first leg of a wire loop for rotation around a center axis thereof and for longitudinal displacement in the direction of the center axis; and
a second through-bore that extends through the hinge body, parallel to the first through-bore and that along its length is open to the outside of the hinge body at one side for releasably receiving the second leg of a wire loop through a pivoting movement of the wire loop around the center axis of the first leg.

2. An audio headphone assembly according to claim 1, wherein the second leg of each wire loop in at least an earpiece listening position is received in the respective hinge body.

3. An audio headphone assembly according to claim 1, wherein the first leg is received with an interference fit in the associated first through-bore.

4. An audio headphone assembly according to claim 2, wherein the second leg is received with a an interference fit in the associated second through-bore.

5. An audio headphone assembly according to claim 1, wherein the hinge bodies are circular cylinders; and
wherein the first and the second through-bores extend perpendicular to a center axis the hinge body, at a distance from each other along the center axis.

6. An audio headphone assembly according to claim 5, wherein the hinge bodies are each supported for rotation at an associated end section of the head band.

7. An audio headphone assembly according to claim 6, wherein each of the hinge bodies is supported for rotation around the center axis of the hinge body, thereby enabling folding of the respective earpieces towards the head band for storage.

8. An audio headphone assembly according to claim 1, wherein the open side of the second through-bore is formed by a groove extending the full length of the second through-bore, from the second through-bore circumference to the outside of the hinge body.

9. An audio headphone assembly according to claim 8, wherein the groove has an arcuate shape that coincides with a portion of a circle being centered on the center axis of the first through-bore.

10. An audio headphone assembly according to claim 9, wherein at least a portion of the arcuate groove is slightly narrower than the cross-sectional dimension of the second leg, thereby presenting a resistance to an insertion of the second leg through the groove and into the second through-bore and to a removal of the second leg from the second through-bore.

11. An audio headphone assembly comprising:
a head band;
a first leg and a second leg having respective first ends that are attached to an earpiece, and respective second ends that are inter-connected; and
an earpiece hinge having
a hinge body mounted on the head band;
a first through-bore extending through the hinge body and receiving the first leg, such that the first leg is rotatable about a center axis of the first leg and relative to the hinge body, and such that the first leg is longitudinally displaceable in the direction of the center axis and relative to the hinge body; and
a second through-bore extending through the hinge body and parallel to the first through-bore, one side of the second through-bore being open along its length to the outside of the hinge body, such that the second through-bore releasably receives the second leg through a pivoting movement of the first leg and the second leg around the center axis of the first leg.
